(19) United States
(12) Patent Application Publication
(10) Pub. No.: US 2009/0201321 A1
(43) Pub. Date: Aug. 13, 2009

(54) INLINE PRINTING OF INVISIBLE INFORMATION WITH AN INK JET IN A DIGITAL PRESS SYSTEM

(75) Inventors: Kurt I. HALFYARD, Mississauga (CA); Gabriel IFTIME, Mississauga (CA); T. Brian MCANENEY, Burlington (CA); Paul F. SMITH, Oakville (CA)

Correspondence Address: OLIFF & BERRIDGE, PLC., P.O. BOX 320850, ALEXANDRIA, VA, 22320-4850, US

(73) Assignee: XEROX CORPORATION, Norwalk, CT (US)

(21) Appl. No.: 12/029,069

(22) Filed: Feb. 11, 2008

(51) Int. Cl. B41J 3/00

(52) U.S. Cl. 347/2

(57) ABSTRACT

A system integrating a digital press with an ink jet device to form a security document, which includes a xerographic portion and an invisible ink portion, produces documents in a continuous inline process.

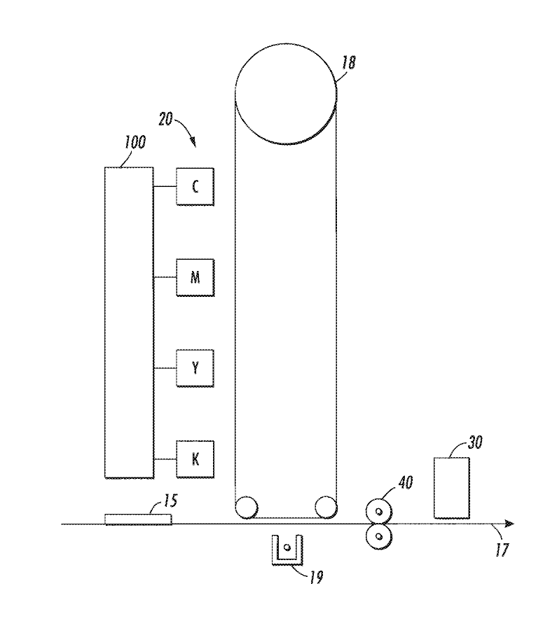

### BACKGROUND

Described herein is a system integrating a digital press with an ink jet device for use in forming a security document containing a xerographic portion and an invisible ink portion. The system can thus be used to produce security or other documents in a continuous inline process.

An especially difficult task with document security is the creation of documents that contain embedded or hidden information the presence of which is not detectable by the naked human eye. One technique being used is to print the information onto the document with clear (colorless) inks that include materials that interact with UV light, for example by fluorescing, so that the information can become visible to the naked human eye upon exposure to the UV light.

For example, U.S. Patent Publication No. 2004/0233465 describes an article marked with image indicia for authentication, information, or decoration by providing a plurality of inks having a plurality of fluorescent colors when exposed to excitation energy, separating colors of the image indicia into a plurality of image levels in accordance with the fluorescence colors of the inks, and printing each image level in mutual registration on the article using the corresponding ink. The image printed with each ink may be substantially invisible tinder illumination within the visible spectrum. The invisibly printed images have multiple authentication features, including the use of covert UL-fluorescent materials, IR-fluorophores, microparticles, and other chemical taggants.

U.S. Pat. No. 5,807,625 describes photochromic printing inks that are used for the printing of security documents. Prints are normally nearly colorless and become colored when energy irradiated, such as by ultraviolet light. This photocoloration is reversible. The printing inks contain photochromic compounds which are protected against other ink components. Methods are described to prepare the inks, to print security documents, and to detect counterfeiting.

However, several problems may be encountered with the above techniques. First, the clear ink used to form the hidden information may have a differential gloss from the document substrate, typically paper, and thus the naked human eye could detect that something is present on the document. A counterfeiter could then investigate further to find the hidden information. Second, even if no differential gloss were evident, the hidden information may still be revealed with the use of a simple black light, and counterfeiters knowing of the prevalent use of UV absorbing inks often will check a document under black light.

Further, production of high quality documents at very high speeds is becoming more and more prevalent, for example due to the continuing advances made in digital press technology and systems, such as the iGen3 device from Xerox Corporation. In prints made using a digital press, if hidden encoded or uncoded information is to be included in a document, the information is typically placed onto the document using the same press technology used to form a remaining portion of the image on the document with conventional toner and/or ink that exhibits a visible color under normal light conditions. While this enables the information to be embedded in the document, the information is unlikely to be truly hidden from others not supposed to know of its presence, for example due to either differential gloss or the use of fluorescent toners/inks that are readily detected under black light, as discussed above.

What is still required is a method and system for embedding hidden coded or uncoded information or images into a document such that the information is substantially undetectable to the naked human eye due to differential gloss, and which is further not detectable or revealed by black light.

### SUMMARY

Described is an integrated printing system for forming images on a substrate, comprising a monochrome or full color digital press for forming visible images on the substrate, and in-line with the digital press, an ink jet device for forming optional security markings on the substrate.

Also described is a method of forming a document that includes hidden security information, comprising forming at least one color image on a substrate with a digital press, wherein the at least one color image on the substrate is visible to a naked human eye under light having wavelengths of 365 nm or more, and forming at least one security marking on the substrate with an ink jet device, wherein the security marking is substantially not detectable to a naked human eye through differential gloss or exposure to light having wavelengths of 365 nm or more, wherein the forming of the at least one color image and the forming of the at least one security marking is performed in-line in an integrated printing system including both the digital press and the ink jet device.

In embodiments, advantages of the printing system and method include that security features can be readily included in a single printing process that also utilizes all of the advantages of digital printing, and thus that security information can be included on a substrate in a digital press system. Other advantages include the ability to employ an ink in an ink jet device that forms hidden security information in a document, which information is invisible to human eyes under light having a wavelength of 365 nm or more (black light and normal light), rendering the security information hard to detect and thus making the document very difficult to copy or counterfeit. Security information thus may be formed on the substrate in a manner substantially not detectable to a naked human eye through differential gloss or exposure to light having wavelengths of 365 nm or more, and thus not detectable under most common conditions used by counterfeiters, but which information can be exposed through exposure of the document to light having a wavelength at which the light absorbing material of the ink absorbs the light. The system and method are cost effective in forming documents at low cost, high speed and with good appearance, with security information included in the document.

### BRIEF DESCRIPTION OF THE DRAWING

The FIGURE is a sketch of an example printing system including both a full color digital printing device and an ink jet device.

### EMBODIMENTS

The printing system herein is an integrated system in which both a digital printing device, hereinafter a digital press, and an ink jet device are used together in the system. That is, both the digital press and the ink jet device are located along the path of the substrate through the system, thereby forming an in-line system in which the substrate passes through and/or by both devices in a single pass through the system. The system may be used for either simplex (one-sided) or duplex (both sides) printing.

The digital press may be any known or future developed digital press device. Many digital presses are commercially available and in use, for example including Xerox's iGen3™, Nuvera™, DocuColor™, DocuTech™ and DocuPrint™ devices, Hewlett-Packard's Indigo™ device, InfoPrint's InfoPrint™ device and the like. Digital presses can be used to form either monochrome (black and white) or full color images on a substrate. In such presses, toner-based images are typically formed on a photoreceptor surface and then transferred to the substrate as it passes, either by direct transfer of the toned image on the photoreceptor surface to the substrate or by indirect transfer in which the toned image is first transferred to an intermediate transfer member and then transferred to the substrate. Any photoreceptor design may be used, including photoreceptors in the forms of belts, drums, and the like. Further details of the operation of the digital press herein are not necessary in view of the availability of the technology in the art.

In addition to the digital press, the device may typically also include a digital front end processor associated with the digital press, a finishing system such as a fuser, and optionally also one or more post finishing systems such as a UV coating system, a glosser system, a laminator system, and the like.

The digital front end processor typically functions to take input electronic files composed of imaging commands and/or images from other input devices such as a scanner or digital camera, together with its own internal other function processes such as raster image processor, image positioning processor, image manipulation processor, color processor, image storage processor, substrate processor, and the like, to rasterize the input electronic files into proper image bitmaps for the digital press to print onto the substrate. An operator may be able to input certain parameters to the digital front end processor through a user interface, for example set up parameters such as layout, font, color, paper, post-finishing, and the like.

The digital press receives the rasterized bitmap and renders the bitmap into a form that can control the printing process form the exposure device to writing the image onto the substrate. The finishing system will typically include a fuser to provide heat to fuse the image to the substrate. The post-finishing system finalizes the print by adding finishing touches such as protection, glossing, binding and the like, as known in the art.

The digital press herein forms one or more images on each substrate, which images are visible to a human eye under normal (ambient) light conditions, that is, under light having wavelengths within the visible light spectrum. Image herein refers to, for example, any text, picture, design, graphic and the like.

In addition to the digital press, the integrated printing system herein also includes at least one ink jet device.

Ink jetting devices are known in the art, and thus extensive description of such devices is not required herein. Any known or future developed ink jet device may be used herein. As described in U.S. Pat. No. 6,547,380, incorporated herein by reference, ink jet printing systems are generally of two types: continuous stream and drop-on-demand. In continuous stream ink jet systems, Ink is emitted in a continuous stream under pressure through at least one orifice or nozzle. The stream is perturbed, causing it to break up into droplets at a fixed distance from the orifice. At the break-up point, the droplets are charged in accordance with digital data signals and passed through an electrostatic field that adjusts the trajectory of each droplet in order to direct it to a gutter for recirculation or a specific location on a recording medium. In drop-on-demand systems, a droplet is expelled from an orifice directly to a position on a recording medium in accordance with digital data signals. A droplet is not formed or expelled unless it is to be placed on the recording medium. There are at least three types of drop-on-demand ink jet systems. One type of drop-on-demand system is a piezoelectric device that has as its major components an ink filled channel or passageway having a nozzle on one end and a piezoelectric transducer near the other end to produce pressure pulses. Another type of drop-on-demand system is known as acoustic ink printing. As is known, an acoustic beam exerts a radiation pressure against objects upon which it impinges. Thus, when an acoustic beam impinges on a free surface (i.e., liquid/air interface) of a pool of liquid from beneath, the radiation pressure which it exerts against the surface of the pool may reach a sufficiently high level to release individual droplets of liquid from the pool, despite the restraining force of surface tension. Focusing the beam on or near the surface of the pool intensifies the radiation pressure it exerts for a given amount of input power. Still another type of drop-on-demand system is known as thermal ink jet, or bubble jet, and produces high velocity droplets. The major components of this type of drop-on-demand system are an ink filed channel having a nozzle on one end and a heat generating resistor near the nozzle. Printing signals representing digital information originate an electric current pulse in a resistive layer within each ink passageway near the orifice or nozzle, causing the ink vehicle (usually water) in the immediate vicinity to vaporize almost instantaneously and create a bubble. The ink at the orifice is forced out as a propelled droplet as the bubble expands.

The ink jet device herein may either jet directly to the substrate, or it may employ transfuse, that is, a transfer and fusing step, in forming a marking on the substrate. Transfuse allows an image to be built up on a rapidly rotating transfer member, and typically involves jetting the ink from the ink jet head onto an intermediate member such as a belt or drum (the transfuse member). This allows the image to be rapidly built onto the transfuse member and then subsequently transferred and fused to the substrate.

In the integrated printing system, the ink jet device may be used to optionally apply one or more security markings onto the substrate that also includes the visible image formed on the substrate by the digital press. The at least one security marking may be formed on the same side of the substrate as the visible image, or may be on the opposite side of the substrate from a visible image.

In the ink jet device, several embodiments are possible. For example, in embodiments, the ink jet device may be made to jet only the ink for forming the hidden security information. In other embodiments, the ink jet device may include separate heads or channels for conventional inks and for the ink for forming the hidden security information, thereby permitting simultaneous printing of additional visible information and the hidden security information.

The at least one security marking is desirably hidden and/or invisible to a naked human eye under light having wavelengths of 365 nm or more, but visible to a naked human eye under light having wavelengths below 350 nm, such as 260 nm or less. In this way, security or secure information may be embedded in a document formed with the integrated printing system and be substantially non-detectable to a person not aware of the presence or location of the information in the document. The ink for use in the ink jet device enabling formation of these security markings oil a substrate are further described below.

In the integrated printing system, the ink jet device may be located either downstream or upstream from the digital press. If upstream, the ink jet device is able to provide pre-printed security paper to the digital press, although care needs to be taken in the subsequent placement of image(s) on the sheet by the digital press so as not to obscure the ink jetted image(s) and/or information. If located downstream, the ink jet device is able to embed security information in a final xerographic image.

Moreover, the ink jet device is desirably located downstream of a fusing device of the system. Of course, it is also possible to locate the ink jet device upstream from a fusing device for the digital press, and in this way the document can be subjected to one single fusing operation to fuse the image and security markings to the substrate. Locating the ink jet device upstream of the fusing device for the digital press formed image, the ink jet ink needs to have compatibility with the fuser, for example the fuser roller, such that there is no significant contamination of the ink jet ink on the roll surface. The ink also needs to exhibit a suitable drying/residence time, for example drying times on the order of milliseconds, that would make the ink compatible with the fuser roller and/or would prevent smudging of the marked image/information.

The ink jet device may be used to print security information in any form, including as human readable text, or as machine readable encoded information such as in a form selected from the group consisting of one-dimensional barcode, two-dimensional barcode, data glyphs, dots and combinations thereof. One dimensional barcodes have a form such as used for UPC codes on products. The two dimensional barcode may be of any suitable type, such as, for example, PDF4171 (based on stacked barcodes), 3-DI, Array Tag, Aztec code, Codablock. Code 16K, CP code, Data Matrix, Datastrip code, Maxicode, Minicode, and the like. The encoded information may also be in the form of data glyphs or dots. In dot code, 0s and 1s are represented by the presence or absence of a dot. Dots refer to, for example, any mark of any shape, and includes, for example, circular or rectangular marks.

In embodiments, the code format is a self-clocking glyph code as disclosed in, for example, U.S. Pat. Nos. 5,128,525 and 5,168,147, the disclosures of each of which are totally incorporated herein by reference. In one embodiment, this code comprises printed glyphs which represent 0 and 1 bits in a document encoding scheme. The glyphs are printed at a substantially uniform distance from each other, so that the center of each glyph is a substantially uniform distance from the center of adjacent glyph(s). These marks can be printed at very high densities of, for example, about 3,600 data bits per square inch or higher, and scanned with a 300 pixel per inch scanner. Data is encoded by the shape or the rotational orientation of the mark. Clocking can be taken from the data itself, without synchronization marks external to the data. By placing a mark at each data bit position, it is easier to synchronize the reading process of the data without the use of registration marks. The number of bits that can be represented by each symbol is related to the total number of symbols in the code; when the number of bits to be represented by a symbol is “n”, the total number of glyphs possible in the code is 2ⁿ distinctive glyphs. For example, in a code wherein two distinct glyphs are possible, such as / and \, each symbol may represent one bit; for example, /=1 and \=0. In a code wherein four distinct glyphs are possible, such as /, -, \, and |, each symbol can represent taco bits; for example, /=00, |=01, \=10, and -=11. In a code wherein eight distinct glyphs are possible, each symbol can represent three bits, and the like. Data can be encoded in the shape of the glyphs, the rotation of the glyphs, or in any other desired variation.

In embodiments, the glyphs are elliptical marks, and in a simple code wherein two distinct shapes are possible, the glyphs preferably are elliptical marks rotated from the vertical at either about +45° (for example, “/”) or −45° (for example “\”). The use of orthogonally-oriented marks potentially allows for a large degree of discrimination between data bit 1 and data bit 0. The marks may be inclined at about 45°, rather than being horizontal or vertical, because (a) there is less tendency for adjacent marks to touch, and (b) printing and scanning non-uniformities tend to be horizontal (banding) or vertical (photodetector array response variations). In an embodiment, the two glyphs may each be elongated multi-pixel symbols having the same number of adjacent “ON” pixels and differ from each other in their rotation from the vertical. These specific glyphs are readily discernible from each other, even in the presence of significant distortion and image degradation, because they do not tend to degrade into a common shape.

In order for the ink jet device to print machine readable encoded information, the ink jet device may have associated therewith an encoding device that provides information in encoded form for the ink jet device to print. The system may thus include one or more processors, for example to convert information to the encoded information, that is, to convert the information to a machine readable code format. A similar processor may be used to decode encoded information detected by a machine reader, that is, convert the encoded information to its original uncoded information form, to recover the encoded information.

The integrated printing system may also optionally include, downstream from the ink jet device, a detection device including a source that emits light at a wavelength of less than 350 nm and matched to the wavelength at which the printed security information absorbs light, that is the wavelength at which the light absorbing material of the ink, described further below, absorbs light. In this way, the security information can be verified upon completion of the printing of the document.

The integrated printing system desirably includes a substrate supply device housing substrate materials to be provided to the system for printing. In embodiments, while any substrate may be used, the substrate housed in the housing is a paper substrate having an average surface roughness of at least about 0.5 microns.

In embodiments where it is desired to achieve an image containing the security information so as to be substantially invisible, and desirably completely invisible, as the result of no gloss differential between the paper substrate and the printed encoded information, paper substrates having a sufficient surface roughness and/or porosity may be selected. For example, papers with sufficient surface roughness and porosity can permit the colorless ink used to form the encoded information to blend and penetrate into the paper such that no gloss differential results.

Surface roughness refers to when the surface of the paper substrate is characterized by microscopic peaks and valleys. The surface roughness of the substrate surface may be measured by observation through a microscope, by optical interferometry, or by measuring the movements of a stylus dragged over the surface. Typical roughness values, which reflect the distances between peaks and valleys of the substrate surface, may range from several microns to tens of microns. For avoiding differential gloss in the hidden information image, a paper substrate having a surface roughness of at least about 0.5 microns, for example from about 1 microns to about 20 microns or from about 2 microns to about 20 microns, may be used. For paper substrates having the aforementioned surface roughness, the paper substrates are typically substantially free of any surface coatings thereon, for example gloss coatings, which may act to reduce the surface roughness and/or reduce the ability of an ink to penetrate into the paper substrate surface.

In addition, the paper substrate may also desirably have a sufficient porosity so as to permit the ink, for example a liquid ink, to penetrate somewhat into the paper substrate. This also appears to assist in the avoidance of differential gloss. The porosity of the substrate may be measured by, for example, air bleed through the substrate, in units of time per volume of air, or by the absorption rate of fluid into the substrate, in units of volume of fluid per unit of time. For avoiding differential gloss in the printed encoded information, a paper substrate having a porosity of about 100 milliliters per minute to about 2,000 milliliters per minute, such as from about 100 milliliters per minute to about 1,500 milliliters per minute or from about 200 milliliters per minute to about 1,500 milliliters per minute, may be used. Typically, uncoated paper has a porosity of from about 500 to about 1,500 milliliters per minute.

Commercially available papers having the above surface roughness and porosity values include, for example, Xerox 4024 and 4200 paper. For example, Xerox 4200 paper has a surface roughness of about 2.5 microns.

The paper may be white paper, or may be colored and have a color other than white. When the paper substrate is white paper, the paper substrate desirably includes an optical brightener.

The purpose of optical brighteners in the paper is typically to remove the yellowish appearance of the raw materials. Optical brighteners increase the brightness of the paper so that a white paper appears even whiter, for example by increasing the intensity of reflected blue light. Optical brighteners typically act to increase whiteness by converting UV light to blue light.

The function of the optical brighteners to emit blue light is utilized in the documents herein. For example, when the document is exposed to light having wavelengths of less than 350 nm, for example less than 300 nm and/or less than 260 nm, the optical brighteners emit blue light. Where the ink is made to include materials that do not absorb at wavelengths above 350 nm, the appearance of the document is not changed upon exposure to such light. Thus, under black light (365 nm), the document has the same appearance and the encoded hidden information is not displayed. However, when the wavelength of the exposing light is less than 350 nm, and more specifically at the wavelength at which a material of the ink absorbs the light, the material will then block light from reaching the optical brightener, and thus no blue light will be emitted at such locations. As a result, the encoded hidden information will become visible to a naked human eye under these light viewing conditions, and thus viewable to a reader in a detection device such that the encoded information can be read and subsequently decoded. The optical brighteners in the paper are thus used in the hiding and exposing of the encoded hidden information printed on the paper substrate.

As optical brighteners, any optical brighteners, organic or inorganic, that emit blue light upon exposure to a broad range of light wavelengths may be used. For example, the optical brightener may emit blue light across a range of from about 100 nm to about 800 nm, such as from about 100 nm to about 700 nm or from about 200 nm to about 500 nm. Examples of typically optical brighteners that may be employed include colloidal silicas, titanium dioxide (for example Rutile or Anatase), hydrated alumina (for example Hydrad), barium sulfate (for example K. C. Blanc Fix HD80, calcium carbonate, high brightness clays (for example Engelhard Paper Clays), Dow plastic pigment (for example 722, 788 Dow Chemicals), calcium silicate, insoluble cellulosic materials (for example from Scientific Polymer Products), tetrasulfonated optical brighteners, for example benzenesulfonic acid, 2,2′-(1-2-ethenediyl)bis[5-[[4-bis(2-hydroxyethyl)amino]-6-[(4-sulfophenyl)amino]-1,3,5-triazin-2-yl]amino]-tetrasodium salt (for example from Ciba Specialty Chemicals Corporation), stilbenes, fluorescent agents, and the like. The optical brighteners may be present in the paper substrate in an amount of from about 1 to about 60 percent by weight of the paper substrate.

While any ink may be employed in the ink jet device, the ink in the ink jet device is desirably for printing the hidden security information onto the substrate and is thus comprised of at least clear binder and light absorbing material that absorbs light only at wavelengths below 350 nm, such as below 260 nm.

As the clear binder, and binder material, for example including oligomeric or polymeric materials, may be used so long as the binder does not absorb light having a wavelength of more than 350 nm. Desirably, the binder should not absorb light having a wavelength or more than 300 nm or more than 260 nm. In this way, the binder also will not be detectable under normal or black light conditions. Examples of suitable binders include, for example, polyacrylates or polymethacrylates such as polymethyl methacrylate, polystyrenes, and polyolefins such as polyethylene, which do not absorb at wavelengths higher than 260 nm. Additional suitable binder materials include polycarbonates, polysulfones, polyethersulfones, polyarylsulfones, polyarylethers, polyvinyl derivatives, cellulose derivatives, polyurethanes, polyamides, polyimides, polyesters, silicone resins, epoxy resins and the like. Copolymer materials such as polystyrene-acrylonitrile, polyethylene-acrylate, vinylidenechloride-vinylchloride, vinylacetate-vinylidene chloride, and styrene-alkyd resins are also examples of suitable binder materials. The copolymers may be block, random, or alternating copolymers.

The binder may be comprised of one, two, three or more different binders. When two or more different binders are present, each binder may be present in an equal or unequal amount by weight ranging, for example, from about 5% to 90%, such as from about 30% to about 50%, based on the weight of all binders.

As the light absorbing material that absorbs light only at wavelengths below 350 nm, any absorbing material that absorbs light at wavelengths below 350 nm, and desirably below 300 nm or below 260 nm, may be used. 365 nm represents black light, and thus it is desired that the light absorbing material not absorb light above or near this wavelength of light. The light absorbing material is thus non-fluorescent in the sense that it does not fluoresce upon exposure to black light. The light absorbing material, which may be organic or inorganic, is also desirably colorless so as not to be detectable to a naked human eve under normal light conditions. The light absorbing material is desirably not fluorescent, as fluorescent materials are detectable under black light.

Examples of the light absorbing material include organic molecules such as, for example, hydroxybenzophenones, hydroxybenzotriazoles, oxanilides, triazines and hindered amine light stabilizers. An example oxanilide is TINUVIN 312 available from Ciba that absorbs light at wavelengths below 350 nm, but does not absorb at wavelengths higher than 350 nm.

Examples of inorganic light absorbing materials include inorganic nanoparticles. The nanoparticles may have an average particle size of about 300 nm or less, for example of from about 1 nm to about 300 nm or from about 10 nm to about 200 nm. The average size of the nanoparticles may be determined via any suitable technique and device, for example via use of a Malvern Zeta-sizer, a Brookhaven nanosize particle analyzer or similar device. Examples of inorganic nanoparticles include, for example, titanium dioxide, aluminum oxide, silicon dioxide, zinc oxide, combinations thereof and the like. These inorganic materials must be of the nanoparticle size in order for the material to be transparent to the naked human eye. A size above 300 nm makes titania appear white, which is not desirable as there may be a detectable difference in white color between the nanoparticles and the paper substrate.

The nanoparticles may be commercially available, for example from Sigma-Aldrich. Alternatively, synthetic procedures for making nanoparticles have been reported in the literature. For example, titanium dioxide nanoparticles may be obtained by hydrolysis of titanium tetrachloride in aqueous hydrochloric acid solution. Another procedure starts from tetrabutyl titanate that is hydrolyzed in anhydrous ethanol in the presence of hydrochloric acid as a catalyst. Zinc oxide may be obtained starting from zinc chloride powder.

The nanoparticles may need to be functionalized in order to be dispersible in the marking material composition. Suitable functional groups present on the surface of the nanoparticles for compatibility with marking material vehicles may include, for example, long linear or branched alkyl groups, for example from about 1 carbon atom to about 150 carbon atoms in length, such as from about 2 carbon atoms to about 125 carbon atoms or from about 3 carbon atoms to about 100 carbon atoms. Other suitable compatibilizing groups include esters, ethers, amides, carbonates and the like. A review on the subject of surface functionalizing inorganic particles may be found in Kohji Yoshinaga, Ch. 12.1, Surface modification of inorganic particles, in Surfactant Science Series (2000), p. 626-646.

The light absorbing material may be included in the marking material in an amount of from, for example, about 0.1% to about 40% by weight, such as from about 1% to about 25% by weight or from about 2% to about 10% by weight, of the marking material.

In embodiments, the clear binder and light absorbing material are in a liquid ink, for example dispersed in a liquid vehicle. As the liquid vehicle of the ink, any suitable vehicle presently known in the art or that may become known in the future may be used. Example liquid vehicles include a liquid with an effective viscosity of, for example, from about 0.5 to about 500 centipoise, such as from about 1 to about 20 centipoise. Specific examples include hexane, toluene, ISOPAR or a polymer such as polyacrylic acid or polyvinyl alcohol. The liquid may be a branched chain aliphatic hydrocarbon. A nonpolar liquid of the ISOPAR series, comprised of isoparaffinic hydrocarbon fractions and manufactured by the Exxon Corporation, may be used. Additional commercially available hydrocarbon liquids that may be used include, for example, the NORPAR, series available from Exxon Corporation, the SOLTROL series available from the Phillips Petroleum Company, and the SHELLSOL series available from the Shell Oil Company.

The amount of the liquid employed in the marking material may be, for example, from about 30 to about 99.9%, for example from abut 50 to about 99%, by weight of the total marking material. The total solids of the liquid marking material may be from, for example, about 0.1 to about 70% by weight, such as from about 0.3 to about 50% by weight, of the marking material.

The use of a liquid vehicle and a porous paper substrate allow the ink to penetrate into the paper substrate instead of being present as a film or coating on the substrate as when toner or solid inks are used. This assists in avoiding differential gloss, making the marking formed from the liquid marking material substantially undetectable to the naked human eye. Moreover, the penetration into the substrate makes it nearly impossible for one to be able to remove the security marking from the paper substrate without damaging or destroying the substrate.

The liquid marking material may include additional materials besides the clear binder, light absorbing material and optional liquid vehicle. However, it is here again desired that any additional components included in the marking material not absorb light at wavelengths greater than 350 nm.

The integrated printing system herein thus is able to employ both a digital press to form at least one color image on the substrate that is visible to a naked human eye under light having wavelengths of 365 nm or more, and an ink jet device to form at least one security marking on the substrate that is not visible to a naked human eye under light having wavelengths of 365 nm or more.

For detection, a document including security information must be exposed to light having a wavelength at which the light absorbing material absorbs light, which light is below 350 nm as detailed herein. An authorized holder of the document will know the wavelength of the light for this absorption. A system for detection and reading of the encoded information desirably includes means that emits light only at the specific wavelength at which the light absorbing material absorbs light, thereby becoming visible and readable upon exposure to such wavelength of light. Exposure of the document to the wavelength of light at which the light absorbing material absorbs light will result in the security information becoming visible to the naked human eye, and thus also to a scanner or machine reader. The scanner may take an image of the visible coded information, which image is sent to a processor for decoding. A machine reader may directly read and decode the encoded information. As detailed above, the image becomes visible under the indicated conditions because the light absorbing material will absorb the incoming light, creating a differential between the marking and the paper substrate that renders the image visible. Removal of the document from this light condition will result in the image again becoming substantially undetectable to the naked human eye.

The FIGURE illustrates an example of an integrated printing system in simple schematic form. In the FIGURE, a substrate 15 enters the digital press 20 printing area along path 17. The digital press is here shown as a full color (C, M, Y and K) press, associated with a digital front end 100, wherein each color is provided onto a belt photoreceptor 18. The example digital press and system are depicted in the FIGURE as being a direct to paper process, that is, having no transfer member, and comprising a belt photoreceptor. However, any digital press design and system may be used as discussed above, including systems using other photoreceptor forms such as drums and systems including transfer members. After receiving the toned image, photoreceptor 18 rotates to transfer the toned image to the substrate at transfer station 19. Thereafter, the substrate proceeds along the path 17 to the ink jet device 30, where the one or more security markings may be optionally printed onto the substrate as detailed above. The substrate thereafter continues downstream to a fusing device 40. Optional finishing systems may be located upstream or downstream of the fusing device, as desired.

Embodiments will now be further illustrated by way of the following examples.

### EXAMPLE

### Invisible Ink Preparation

Water-dispersible invisible titania nanoparticles were prepared by adapting a synthetic method (described in WO 2006/048030, incorporated herein by reference). Under an argon atmosphere, a flask having a condenser was filled with 300 ml of diethyleneglycol. The solvent was degassed wider vacuum, then placed under argon. 10 ml of titanium tetrachloride was added, followed by 5 ml of distilled water. The flask was heated at 160° C. for 3.5 hours. After cooling to room temperature, the solution was slowly poured into acetone placed in an Erlenmeyer flask, while stirring. A white precipitate was immediately formed. The precipitate was isolated by centrifugation (3000 rpm for 5 minutes) and washed twice with acetone, which was removed by centrifugation. The solid was dried under vacuum. The particles were dispersible in water, giving a clear solution with no white precipitate. The particle size, measured using a Malvern sizer, was 16 nm.

A printing ink was prepared by dispersing 330 mg of the nanoparticles in 5 ml distilled water. The clear solution was filtered for any dust impurities using a 0.2 micron filter. The ink was then printed using a Dimatix inkjet printer in which the cartridge was filled with the invisible ink.

### Example 1

A one dimensional UPC barcode was printed as described above. The barcode was invisible under normal light and under black light. However, the barcode became visible upon exposure to 254 nm light. The barcode was successfully read by a scanner and the processor correctly provided the correct decoded information.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. An integrated printing system for forming images on a substrate, comprising:
a monochrome or full color digital press for forming visible images on the substrate; and
in-line with the digital press, an ink jet device for forming optional security markings on the substrate.

2. The integrated printing system according to claim 1, wherein the digital press includes a digital front end processor that rasterizes input electronic files into proper image bitmaps for the digital press to print.

3. The integrated printing system according to claim 1, wherein the ink jet device is associated with an encoding device that provides information in encoded form for the ink jet device to print.

4. The integrated printing system according to claim 1, wherein the ink jet device is located downstream from the digital press.

5. The integrated printing system according to claim 1, wherein the integrated printing system further includes a fusing device downstream from the digital press, and the ink jet device is located downstream of the fusing device.

6. The integrated printing system according to claim 1, wherein the ink jet device includes ink comprised of clear binder and light absorbing material that absorbs light only at wavelengths below 350 nm.

7. The integrated printing system according to claim 6, wherein the light absorbing material absorbs light only at wavelengths below 260 nm.

8. The integrated printing system according to claim 6, wherein the security information is in a form selected from the group consisting of text, one-dimensional barcode, two-dimensional barcode, data glyphs, dots and combinations thereof.

9. The integrated printing system according to claim 6, wherein the clear binder comprises polymethyl methacrylate, polystyrene, polyethylene, polycarbonates, polysulfones, polyethersulfones, polyarylsulfones, polyarylethers, polyvinyl derivatives, cellulose derivatives, polyurethanes, polyamides, polyimides, polyesters, silicone resins, epoxy resins or mixtures thereof.

10. The integrated printing system according to claim 6, wherein the light absorbing material comprises nanoparticles having an average particle size of 300 nm or less and comprise zinc oxide, silica, alumina, titania or mixtures thereof.

11. The integrated printing system according to claim 6, wherein the light absorbing material comprises an organic material selected from the group consisting of hydroxybenzophenones, hydroxybenzotriazoles, oxanilides, triazines, hindered amine light stabilizers, and mixtures thereof.

12. The integrated printing system according to claim 6, wherein the integrated printing system further includes, downstream from the ink jet device, a detection device including a source that emits light at a wavelength of less than 350 nm and matched to the wavelength at which the light absorbing material absorbs light.

13. The integrated printing system according to claim 1, wherein the integrated printing system further includes a substrate supply device housing a paper substrate having an average surface roughness of at least about 0.5 microns.

14. The integrated printing system according to claim 13, wherein the paper substrate is substantially white and includes one or more optical brighteners.

15. The integrated printing system according to claim 1, wherein the digital press forms at least one color image on the substrate that is visible to a naked human eye under light having wavelengths of 365 nm or more, and wherein the ink jet device forms at least one security marking on the substrate that is not visible to a naked human eye under light having wavelengths of 365 nm or more.

16. A method of forming a document that includes hidden security information, comprising:
forming at least one color image on a substrate with a digital press, wherein the at least one color image on the substrate is visible to a naked human eye under light having wavelengths of 365 nm or more, and
forming at least one security marking on the substrate with an ink jet device, wherein the security marking is substantially not detectable to a naked human eye through differential gloss or exposure to light having wavelengths of 365 nm or more,
wherein the forming of the at least one color image and the forming of the at least one security marking is performed in-line in an integrated printing system including both the digital press and the ink jet device.

17. The method according to claim 16, wherein the method further comprises providing the substrate as a paper substrate having an average surface roughness of at least about 0.5 microns.

18. The method according to claim 16, wherein the ink jet device jets an ink comprised of clear binder and light absorbing material that absorbs light only at wavelengths below 350 nm, wherein the light absorbing material comprises nanoparticles having an average particle size of 300 nm or less and comprised of zinc oxide, silica, alumina, titania or mixtures thereof.

19. The method according to claim 16, wherein the ink jet device jets an ink comprised of clear binder and light absorbing material that absorbs light only at wavelengths below 350 nm, wherein the light absorbing material comprises an organic material selected from the group consisting of hydroxybenzophenones, hydroxybenzotriazoles, oxanilides, triazines, hindered amine light stabilizers, and mixtures thereof.

20. The method according to claim 16, wherein the method further comprises exposing the printed document to light having a wavelength of less than 350 nm and at which the light absorbing material absorbs the light, thereby revealing the security information to the naked human eye and permitting reading of the security information by a human or machine.
